(19) United States
(12) Patent Application Publication
(10) Pub. No.: US 2024/0264329 A1
(43) Pub. Date: Aug. 8, 2024

(54) SYSTEM AND METHOD OF OBJECT DETECTION USING A MULTI PROPERTY ARRAY BASED OBJECT DETECTION SYSTEM

(71) Applicant: Xtract One Technologies, Toronto (CA)

(72) Inventors: Elliot Mark HOLTMAN, Vancouver (CA); Nico VAN DEN HOOFF, Vancouver (CA); Jacky KAM, Vancouver (CA)

(21) Appl. No.: 18/432,826

(22) Filed: Feb. 5, 2024

Related U.S. Application Data
(60) Provisional application No. 63/483,297, filed on Feb. 5, 2023.

(51) Int. Cl. G01V 3/10; G06V 20/52

(52) U.S. Cl. CPC G01V 3/107; G06V 20/52; G06V 2201/05

(57) ABSTRACT

A system and method of object detection using a multi-property array-based object detection system. A hybrid multi-sensor gateway (MSG) system combines transmitters and receivers into a single gateway. The hybrid system consists of the backbone of a multi-sensor gateway system with an active transmitter loop which induces eddy currents to flow within conductive targets. Acquisition parameters such as transmitter pulse base frequency, waveform shape, ramp-time and peak current can be modified and tuned to the specific applications and expected targets.

### CROSS REFERENCE TO RELATED APPLICATIONS

The application claims priority to and the benefits of U.S. Provisional Application Ser. No. 63/483,297, entitled “SYSTEM AND METHOD OF OBJECT DETECTION USING A MULTI PROPERTY ARRAY BASED OBJECT DETECTION SYSTEM” filed on Feb. 5, 2023, the disclosure of which is incorporated herein by reference in its entirety.

### BACKGROUND

The embodiments described herein relate to security and surveillance, in particular, technologies related to threat detection systems.

The optimal physical properties which can be used to discriminate objects may vary between objects. For example, some small knives may have strongly magnetized blades which make them good targets to be picked up using passive magnetic methods and remnant susceptibility, while larger objects with more metal and high conductance may be better picked up and discriminated through eddy currents and active electromagnetic methods.

Currently, a multi-sensor gateway threat detection system (i.e., MSG1), such as the one provided by Xtract One Technologies™, is good at detecting small, magnetized objects such as knives with small blades as they are often strongly magnetized to the level that even a small amount of metal can be detected by the system. For many gateway users, it is more important to not miss threat objects (i.e., high true positive rate), even if this trade-off comes at a higher false positive rate.

While the current MSG 1 system may be able to pick up some very small objects, the performance may degrade significantly in the presence of other benign clutter objects as the data likely contains little information about the geometry of the object. Furthermore, MSG 1 has limitations with respect to background noise in some high EMI environments due to the low frequency data band and passive nature of the system.

A further multi-sensor gateway system (i.e., MSG 2.0) was developed to improve performance both with single object walkthroughs and more complicated scenarios with multi-objects and clutter. Small objects with less metal mass and lower conductivity can produce no measurable data response and therefore not be discriminated with the current version of the technology.

It may be desirable to have a combined hybrid multi-physics solution that combines the best of both solutions (transmitters, receivers, etc.) into a single combined hybrid gateway.

### SUMMARY

A system and method of object detection using a multi-property array-based object detection system. A hybrid multi-sensor gateway (MSG) system combines the two current transmitters and receivers into a single gateway. The hybrid system consists of the backbone of a multi-sensor gateway system with an active transmitter loop which induces eddy currents to flow within conductive targets. Acquisition parameters, such as transmitter pulse base frequency, waveform shape, ramp-time and peak current, can be modified and tuned to the specific applications and expected targets.

### BRIEF DESCRIPTION OF THE DRAWINGS

FIGS. 1A-1C are diagrams illustrating an exemplary threat detection system.

FIG. 2 is a block diagram illustrating an exemplary planter box threat detection system.

FIG. 3 are a plurality of charts illustrating data from a medium Kabar knife.

FIG. 4 is a diagram illustrating an exemplary hybrid threat detection system.

### DETAILED DESCRIPTION

Embodiments of this disclosure include a system that places the computing at the edge by including an onboard processor. Further, different peripherals are added to present the alert information to the security guard, as well as control the throughput rate and operations. This system benefits the patron experience and provides added value to the customer in terms of managing throughput and enhancing security.

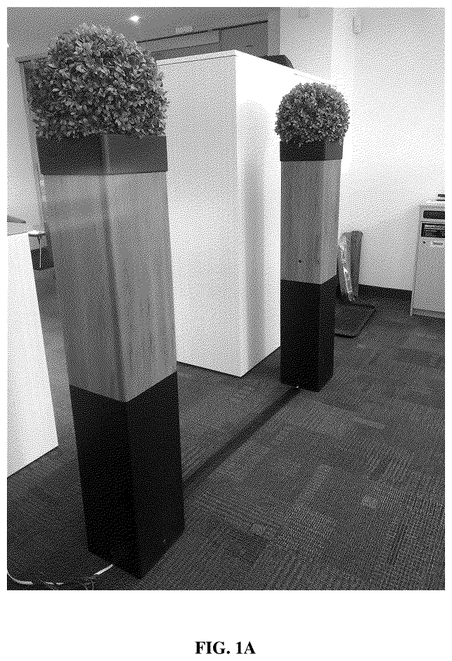

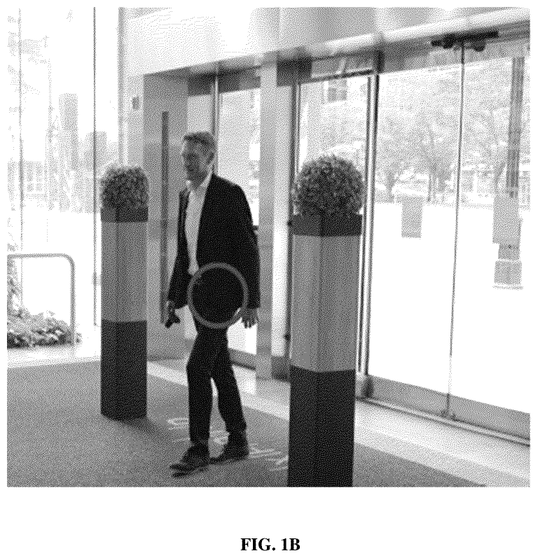

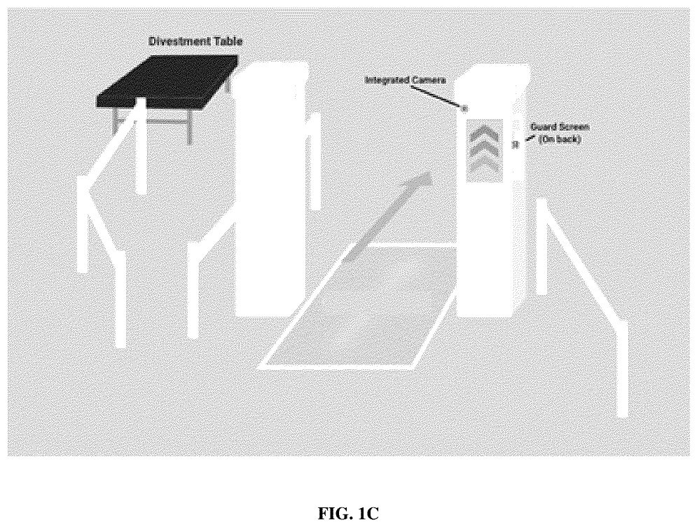

FIGS. 1A-1C are diagrams illustrating an exemplary threat detection system deployed in planter boxes. FIGS. 1A-1C illustrated an exemplary threat detection system deployed in planter boxes. According to these figures, the planter boxes are deployed at the entrance to an office and/or a pair of pillars to control entry. A pair of planter box columns are placed sufficiently far apart (i.e., 2 meters).

Decorative plants, either fake or real, are placed on the planter boxes. The planter boxes or planter box columns are connected via concealed wires where a cover is placed on top. The concealed wires provide power and Ethernet connection between both columns. In further embodiments, the concealed wires can be replaced with a wireless connection or another type of data connection. The planter box columns contain sensors to implement a threat detection system. At least one of the columns will also have a power cord and/or connection to the internet.

FIG. 1B is a diagram of an exemplary threat detection system deployed in planter boxes in a front entrance of a building. As seen in FIG. 1B, two planter box columns are placed by the front door in a building. A person can be seen entering the building, walking through these planter box columns.

A threat detection system using a multi-sensor gateway (MSG), such as the Patriot One PATSCAN MSG, offers detection of concealed weapons on people and in bags using artificial intelligence (AI) and/or machine learning (ML) coupled with magnetic moment techniques. The multi-sensor gateway (MSG) allows for the discovery of a “weapon signature” (i.e., object shape such as handguns, rifles, knives or bombs). Its configuration can detect and identify where on the individual's body or bag the metal threat object resides.

As seen in FIG. 1B, the MSG threat detection system can detect a concealed object (i.e., round circle in image) and may infer that this can be a weapon threat. This information is sent to a central processor and is provided to an operator, to security officers or to police enforcement. Further, the MSG threat detection system may be connected to an alert system where lights and sounds can be triggered once a threat is detected.

FIG. 1C is a diagram illustrating a standalone SmartGateway system. According to FIG. 1C the standalone SmartGateway system consists of two pillars of a threat detection system. One of these pillars will have an integrated camera, a display screen and a guard screen (not shown). There may also be arrows to indicate direction of traffic flow. Close by would be a divestment table where security personnel may search objects of the patron (e.g., backpack, handbag, laptop bags, etc.).

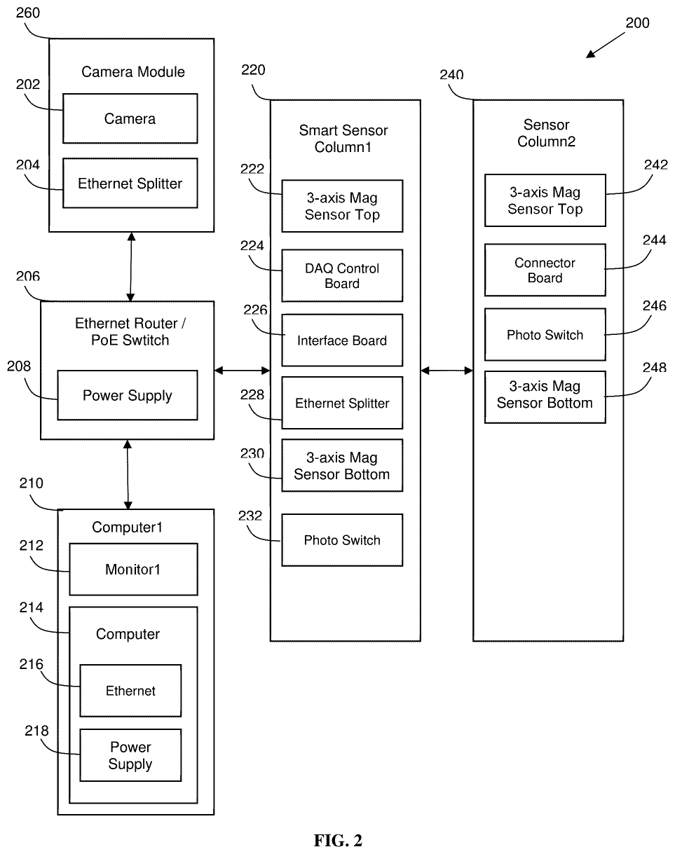

FIG. 2 is a block diagram illustrating an exemplary planter box threat detection system. According to FIG. 2, the threat detection system 200 consists of a first sensor column 220 (i.e., smart column) which includes a photoelectric sensor 232 (e.g., photo switch), a power supply 232, a computer control board 224 (e.g., an acquisition board), an interface board 226, a plurality of 3-axis magnetic sensors 222, 230. Connection interfaces for ethernet router 206, ethernet splitter 204, 228 and ethernet PoE (power over Ethernet) is also provided. Photoelectric sensor 232 may also include a photo emitter.

While Ethernet, and in particular powered Ethernet, provides many advantages in reliably connecting the columns to the data analysis computer, several other power and connectivity options are available that would have a different set of advantages; for example, connections to route the data could be WiFi® connections, BlueTooth® connections, short range wireless, WAN or cellular connections. In addition, power can be supplied to the columns via several means, including direct AC power connections, PoE, 12V DC connections, or battery connections. In future embodiments, first sensor column 220 may incorporate a computer processor.

The threat detection system 200 also consists of a second sensor column 240 comprising a second photoelectric sensor 246 (e.g., photo switch), a connector board 244 and a plurality of 3-axis magnetic sensors 242 and 248. A plurality of wires is provided to connect the interface board 226 of the first column 220 with the connector board 244 of the second column 240. Photoelectric sensors or photo switches 246, 232 are optical sensors that detect motion when people pass through. In further embodiments, sensor columns 220, 240 may include dedicated power supplies.

Attached to the first smart sensor column 220 are elements including an ethernet router and PoE (Power over Ethernet) switch 206, which can be connected to a 48V power supply 208, a computer system 210 and a camera module 260. The computer system 210 consists of monitor 212 and computer 214 which may be a laptop or small size computer unit. Computer 214 further comprises a computer processor (not shown), power supply 218 and ethernet connection 216. Camera module 260 consists of one or more camera 202 and ethernet splitter 204.

In further embodiments, the computer 210, 214 may be replaced by a processor housed within the sensor columns 220, 240. In further embodiments, the ethernet connection of threat detection system 200 may be replaced with a Bluetooth®, cellular, WiFI® or other wireless connection, thus removing the need for running ethernet cables.

According to the disclosure, a hybrid multi-sensor gateway (MSG) system combines the two current MSG 1 & MSG 2 system transmitters and receivers into a single gateway. The hybrid system consists of the backbone of the multi-sensor gateway system (e.g., MSG 2 system) with an active transmitter loop which induces eddy currents to flow within conductive targets. Acquisition parameters such as transmitter pulse base frequency, waveform shape, ramp-time and peak current can be modified and tuned to the specific applications and expected targets.

MSG 1 sensors are added to the system. While both MSG 1 and MSG 2 sensors are inductive coil sensors, the MSG 1 sensors are wound around a very high susceptibility material which greatly increases the sensitivity of the sensors. The downside of this core material is the MSG 2 transmitter can cause issues with the gain and saturation of the core material of the sensors and response causing artifacts.

The MSG 1 sensors are tuned for a much lower frequency than the MSG 2 sensors, typically recording responses in the 0.3-30 Hz frequency range which is needed to measure the low frequency passive response as magnetized objects pass through the gateway. Different embodiments of the hybrid system are possible including or not including the addition of the static magnetic array.

Further embodiments of the system are possible to combine transmitters and two types of receivers for getting usable data off the MSG 1 sensors while still using the active 2.0 transmitter. The first option is to leverage hardware filters and non-overlapping frequency ranges of the components. By using a higher frequency spectrum of the active transmitters (a few ms for a transmitter pulse) and the low frequency 0.3 Hz-10 Hz range of the 1.0 sensors, one can create frequency bands that don't overlap significantly so any active source pulse may be filtered out. Alternative embodiments are possible, where longer off-times are created for the MSG 2.0 transmitter pulses—in the long off-time regions between pulses, clean passive MSG 1 data could be collected with those sensors.

Alternative embodiments are also possible, where the MSG 2 transmitter is only fired during specific parts of the walk-through likely triggered from optical sensors or motion information. Various potential options include collecting active data at the midpoint of the walkthrough or first/second half of the walk through, while collecting passive data through the other portion of the walkthrough.

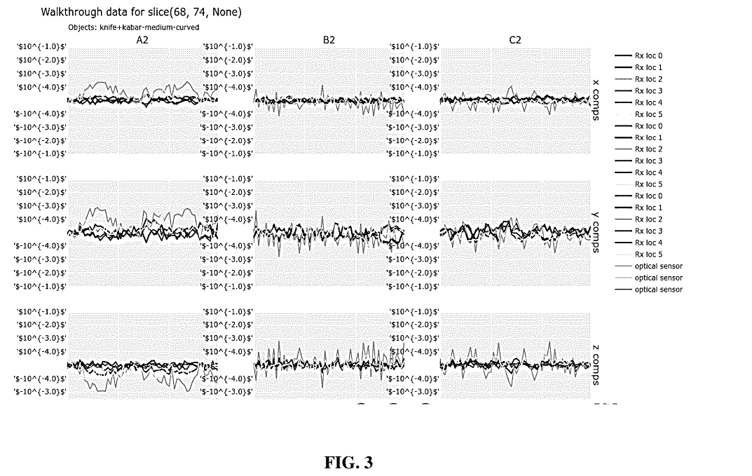

FIG. 3 are a plurality of charts illustrating data from a medium Kabar knife. According to FIG. 3, the plurality of charts illustrate data collected from an exemplary hybrid system of a medium Kabar knife. As shown in FIG. 3, there is not a measurable response at three different carry positions through the gateway (figure columns A2-B2, C2). Each figure panel shows the response amplitude vs walkthrough positions for the various sensor three-dimensional data components. As can be seen from each figure, there is no measurable response as the object is moved through the gateway and only incoherent noise is observed. This means that this sensor configuration could not detect or classify this type of object.

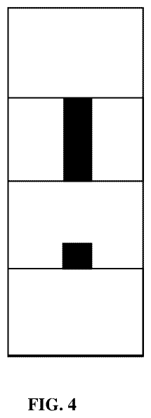

FIG. 4 is a diagram illustrating an exemplary hybrid threat detection system. According to FIG. 4, a hybrid multi-sensor gateway system showing mounting of the long and thin coils and larger printed circuit board (PCB) sensors on a planter box or pillar tower.

According to the disclosure, the hybrid system will combine features of both MSG 1 and MSG 2. The hybrid system will have magnet array technologies and will would simultaneously record information about all three properties including electrical conductivity, induced magnetization and remnant magnetization.

According to the disclosure, a hybrid multi-sensor gateway apparatus configured for multi-property array-based object detection is disclosed. The gateway apparatus comprises a first pillar having a plurality of first sensors, a second pillar having a plurality of second sensors, a printed circuit board (PCB) on the first or second pillar, configured to support the plurality of sensors, a platform computer server and processor configured to receive data and process the data and one or more active transmitters and receivers on the first or second pillars configured to support acquisition parameters and to induce eddy currents to flow within conductive targets. The one or more inductive coil sensors on the first or second pillars. The active transmitters and receivers are tuned or optimized for data collection from the sensors.

According to the disclosure, the active transmitter of the hybrid apparatus further comprises active transmitter loops or transmitter coils. The hybrid apparatus further comprises an integrated camera on the first or second pillar. The hybrid apparatus of Claim 1 further comprising a Wi-Fi® module on the first pillar configured for the pillars to communicate over the Wi-Fi® protocol.

According to the disclosure, the acquisition parameters of the hybrid apparatus is selected from a list consisting of transmitter pulse base frequency, waveform shape, ramp-time and peak current etc. can be modified and tuned to the specific applications and expected targets. The magnet array technology of the hybrid apparatus is configured to simultaneously record information on all three properties including electrical conductivity, induced magnetization and remnant magnetization.

According to the disclosure, the sensors of the hybrid apparatus are tuned or enabled not to interfere with each other. The sensors of the hybrid apparatus are tuned to a lower frequency in the range of 0.3-30 Hz frequency range which is needed to measure the low frequency passive response as magnetized objects pass through the gateway.

According to the disclosure, the hybrid apparatus further comprises hardware filters and non-overlapping frequency ranges of the components to retrieve data from the sensors. The first and second pillar of the hybrid apparatus are configured as planter boxes or bollard posts.

According to a further disclosure, longer off-times are created for transmitter pulses—in the long-off time regions between pulses and clean passive data could be collected with those sensors.

According to a further disclosure, optical sensors can be incorporated that only turns on the hybrid apparatus if it detects a person or patron walking through the hybrid gateway apparatus.

According to a further disclosure, the transmitter is only fired during specific parts of the walk-through likely triggered off optical sensors or motion information. Various potential options include collecting active data at the midpoint of the walkthrough or first or second half of the walk through, while collecting passive data through the other portion of the walkthrough.

According to the disclosure, a computer-implemented method for object detection, using a computer processor and a hybrid array-based multi-sensor gateway system is disclosed. The method comprises the steps of providing a first pillar having a plurality of first sensors, providing a second pillar having a plurality of second sensors, providing an integrated camera on the first or second pillar, providing a platform computer server and processor configured to receive data and process the data, providing a printed circuit board (PCB) on the first or second pillar, configured to support the plurality of sensors, providing one or more active transmitters and receivers on the first or second pillars configured to support acquisition parameters and to induce eddy currents to flow within conductive targets, providing one or more inductive coil sensors on the first or second pillars and receiving data from the plurality of sensors, analyzing the data using the acquisition parameters and transmitting the data to operations and security personnel. The active transmitters and receivers are tuned or optimized for data collection from the sensors.

According to the disclosure, the active transmitter of the method further comprises active transmitter loops or transmitter coils. The method further comprises an integrated camera on the first or second pillar. The method further comprises a Wi-Fi® module on the first pillar configured for the pillars to communicate over the Wi-Fi® protocol.

According to the disclosure, the acquisition parameters of the method is selected from a list consisting of a transmitter pulse base frequency, waveform shape, ramp-time and peak current etc. and can be modified and tuned to the specific applications and expected targets.

According to the disclosure, the magnet array technology of the method is configured to simultaneously record information on all three properties including electrical conductivity, induced magnetization and remnant magnetization. The sensors of the method are tuned or enabled not to interfere with each other. The sensors of the method are tuned to a lower frequency in the range of 0.3-30 Hz frequency range which is needed to measure the low frequency passive response as magnetized objects pass through the gateway.

According to the disclosure, the method further comprises hardware filters and non-overlapping frequency ranges of the components to retrieve data from the sensors. The first and second pillars of the method are configured as planter boxes or bollard posts.

According to further disclosures, the method further comprises hardware filters and non-overlapping frequency ranges of the components to retrieve data from the sensors. The first and second pillar of the hybrid apparatus are configured as planter boxes or bollard posts.

According to a further disclosure, longer off-times are created for transmitter pulses of the method—in the long-off time regions between pulses and clean passive data could be collected with those sensors.

According to a further disclosure, optical sensors can be incorporated that only turns on in the method if it detects a person or patron walking through the hybrid gateway apparatus.

According to a further disclosure, the transmitter of the method is only fired during specific parts of the walk-through likely triggered off optical sensors or motion information. Various potential options include collecting active data at the midpoint of the walkthrough or first/second half of the walk through, while collecting passive data through the other portion of the walkthrough.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A hybrid multi-sensor gateway apparatus configured for multi-property array-based object detection, the gateway apparatus comprising:
a first pillar having a plurality of first sensors;
a second pillar having a plurality of second sensors;
a printed circuit board (PCB) on the first or second pillar, configured to support the plurality of sensors;
a platform computer server and processor configured to receive data and process the data; and
one or more active transmitters and receivers on the first or second pillars configured to support acquisition parameters and to induce eddy currents to flow within conductive targets;
one or more inductive coil sensors on the first or second pillars; and
wherein the active transmitters and receivers are optimized for data collection from the sensors.

2. The hybrid apparatus of claim 1 wherein the active transmitter further comprising active transmitter loops or transmitter coils.

3. The hybrid apparatus of claim 1 further comprising an integrated camera on the first or second pillar.

4. The hybrid apparatus of claim 1 further comprising a Wi-Fi® module on the first pillar configured for the pillars to communicate over the Wi-Fi® protocol.

5. The hybrid apparatus of claim 1 wherein the acquisition parameters is selected from a list consisting of transmitter pulse base frequency, waveform shape, ramp-time and peak current, whereby the acquisition parameters can be modified and tuned to the specific applications and expected targets.

6. The hybrid apparatus of claim 1 wherein the magnet array technology is configured to simultaneously record information on all three properties including electrical conductivity, induced magnetization and remnant magnetization.

7. The hybrid apparatus of claim 1 wherein the sensors are tuned or enabled not to interfere with each other.

8. The hybrid apparatus of claim 1 wherein the sensors are tuned to a lower frequency in the range of 0.3-30 Hz frequency range which is needed to measure the low frequency passive response as magnetized objects pass through the gateway.

9. The hybrid apparatus of claim 1 further comprising hardware filters and non-overlapping frequency ranges of the components to retrieve data from the sensors.

10. The hybrid apparatus of claim 1 wherein the first and second pillar are configured as planter boxes or bollard posts.

11. A computer-implemented method for object detection, using a computer processor and a hybrid array-based multi-sensor gateway system, the method comprising the steps of:
providing a first pillar having a plurality of first sensors;
providing a second pillar having a plurality of second sensors;
providing an integrated camera on the first or second pillar;
providing a platform computer server and processor configured to receive data and process the data;
providing a printed circuit board (PCB) on the first or second pillar, configured to support the plurality of sensors;
providing one or more active transmitters and receivers on the first or second pillars configured to support acquisition parameters and to induce eddy currents to flow within conductive targets;
providing one or more inductive coil sensors on the first or second pillars; and
receiving data from the plurality of sensors;
analyzing the data using the acquisition parameters; and
transmitting the data to operations and security personnel;
wherein the active transmitters and receivers are optimized for data collection from the sensors.

12. The method of claim 11 wherein the active transmitter further comprising active transmitter loops or transmitter coils.

13. The method of claim 11 further comprising an integrated camera on the first or second pillar.

14. The method of claim 11 further comprising a Wi-Fi® module on the first pillar configured for the pillars to communicate over the Wi-Fi® protocol.

15. The method of claim 11 wherein the acquisition parameters is selected from a list consisting of transmitter pulse base frequency, waveform shape, ramp-time and peak current, whereby the acquisition parameters can be modified and tuned to the specific applications and expected targets.

16. The method of claim 11 wherein the magnet array technology is configured to simultaneously record information on all three properties including electrical conductivity, induced magnetization and remnant magnetization.

17. The method of claim 11 wherein the sensors are tuned or enabled not to interfere with each other.

18. The method of claim 11 wherein the sensors are tuned to a lower frequency in the range of 0.3-30 Hz frequency range which is needed to measure the low frequency passive response as magnetized objects pass through the gateway.

19. The method of claim 11 further comprising hardware filters and non-overlapping frequency ranges of the components to retrieve data from the sensors.

20. The method of claim 11 wherein the first and second pillar are configured as planter boxes or bollard posts.
